(19) United States
(12) Patent Application Publication
(10) Pub. No.: US 2006/0052940 A1
(43) Pub. Date: Mar. 9, 2006

(54) System and method for identifying test kit types

(75) Inventor: Zhouhong Shi, Waukesha, WI (US)

Correspondence Address: FOLEY & LARDNER LLP, 777 EAST WISCONSIN AVENUE, SUITE 3800, MILWAUKEE, WI, 53202-5308, US

(73) Assignee: Dynal Biotech ASA

(21) Appl. No.: 10/933,548

(22) Filed: Sep. 3, 2004

(51) Int. Cl. G06F 19/00

(52) U.S. Cl. 702/19

(57) ABSTRACT

An analysis data interpretation system configured to automatically identify a test kit type used to generate a laboratory system output file. The system includes an analysis data interpretation processor configured to receive a laboratory system output file including a test kit identifier to identify the test kit that was used to generate the laboratory system output file.

### BACKGROUND OF THE INVENTION

The present invention relates generally to the field of systems and methods for automating a genotyping process. More particularly, the present invention relates to a system and method for automatically identifying a testing kit including a wavelength generated by any chemical reaction.

Testing kits may include any type of testing kit configured to produce or facilitate a chemical reaction. Exemplary testing kits may be in a variety of fields, such as genotyping, antibody screening, cross-matching, expression analysis, inorganic identification screening, etc. Generally, testing kits including are configured to receive a sample to be tested and also receive or include some type of reactant configured to interact with the sample to be tested. The testing kit may be configured to have a wavelength, e.g. a color, associated with the end product of the chemical reaction.

One type of test kit may be associated with human leukocyte antigen typing. Human Leukocyte Antigens (HLA) are proteins that are located on the surface of white blood cells and other tissues in the body. There are two classes of HLA genes (Class I and Class II), and within each class, there are multiple groups of genes encoding specific HLA proteins. HLAs are important in the field of organ, tissue, and bone marrow transplant in determining whether a patient is likely to reject the donor. HLA is the most polymorphic region in the human genome, methodologies developed for HLA typing are applicable to typing of all polymorphic genomic regions.

In predicting whether a recipient is likely to reject the donor, an HLA typing test is performed for both the donor and the patient. Antibodies are proteins, present in the serum, which may attack the donor tissue by attacking the HLA. Antibody screening determines whether antibody to HLA antigens is present in the patient serum. A cross match test may be performed by mixing a very small amount of the patient's serum with a very small amount of the potential donor's lymphocytes. If the patient has antibody to the patient's HLA, the donor's cells will be injured, referred to as a “positive crossmatch”.

Test kits may be utilized in the HLA typing test to facilitate the identification and definition of the Histocompatiblity Antigens. There are a large number and variety of testing kits available that are configured in a variety of ways to facilitate performance of the HLA typing test. These test kits may then be processed to determine an HLA type. Traditionally, a human operator had to identify the type of HLA test kit that was used in order to correctly analyze the output. The human input reduced the automation of the process and introduced a possible source of error.

What is needed is a system and method for automatically identifying a test kit type for a test kit configured to generate a wavelength based on a chemical reaction. What is further needed is such a system and method configured to utilize an identifier in the within the HLA typing test kit to provide for automated identification. Yet further, what is needed is a program product configured to automatically recognize a test kit type based on an identifier within the test kit.

### SUMMARY OF THE INVENTION

One embodiment of the invention relates to an analysis data interpretation system configured to automatically identify a test kit type used to generate a laboratory system output file. The system includes an analysis data interpretation processor configured to receive a laboratory system output file including a test kit identifier to identify the test kit that was used to generate the laboratory system output file.

Another embodiment of the invention relates to a method for identifying a test kit type used to generate a laboratory system output file. The method includes receiving a laboratory system output file, identifying a test kit type used to generate a laboratory system output file based on the content of the laboratory system output file, and generating an human leukocyte antigen typing based at least in part on the test kit identifier.

Yet another embodiment of the invention relates to an analysis data interpretation system configured to automatically identify a test kit type used to generate a laboratory system output file. The system includes an analysis data interpretation means configured to receive a laboratory system output file including a test kit identifier to identify the test kit that was used to generate the laboratory system output file.

Other features and advantages of the present invention will become apparent from the following detailed description and accompanying drawings. It should be understood, however, that the detailed description and specific examples are given by way of illustration and not limitation. Many modifications and changes within the scope of the present invention may be made without departing from the spirit thereof, and the invention includes all such modifications.

### BRIEF DESCRIPTION OF THE DRAWINGS

The exemplary embodiments will hereafter be described with reference to the accompanying drawings, wherein like numerals depict like elements, and:

FIG. 1 is a block diagram illustrating a bioassay analysis system for determining a human leukocyte antigen (HLA) genotype, according to an exemplary embodiment; and

FIG. 2 is a flowchart illustrating a method of automatically determining a test kit type used to generate a laboratory analysis system output file, according to an exemplary embodiment

### DETAILED DESCRIPTION OF THE PREFERRED EMBODIMENTS

In the following description, for the purposes of explanation, numerous details are set forth in order to provide a thorough understanding of the present invention. It will be evident to one skilled in the art, however, that the exemplary embodiments may be practiced without these specific details. In other instances, structures and device are shown in diagram form in order to facilitate description of the exemplary embodiments.

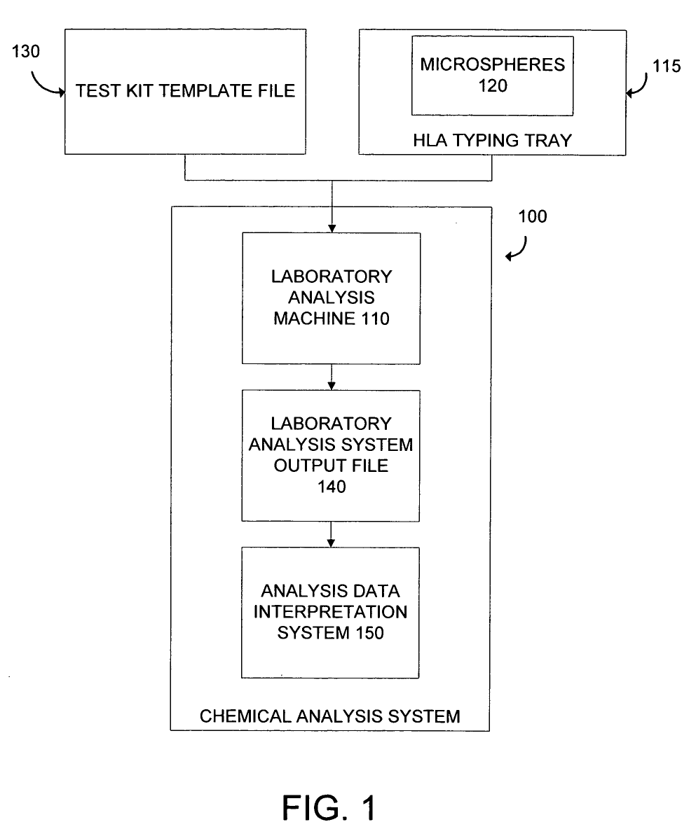

Referring to FIG. 1, a block diagram illustrating a chemical analysis system 100 for analyzing a chemical reaction. Analysis system 100 is configured to analyze a wavelength generated as the end product of a chemical reaction. The end product may be formed based on any type of analysis. Exemplary fields for the analysis include genotyping (including at least DNA analysis), antibody screening (including antigen/antibody interactions), cross matching, expression analysis, inorganic identification screening (including identification performed within forensic science), inorganic screening (e.g., the amount of a metal present in a large pool), etc.

According to an exemplary embodiment, chemical analysis system 100 may be a bioassay analysis system configured for determining a human leukocyte antigen (HLA) genotype is shown. For the purpose of this detailed description, system 100 will be described with reference to Human Leukocyte Antigen (HLA) Typing, although those skilled in the art will recognize that the systems and methods described herein may be applied to analysis of any chemical reaction producing quantifiable end point signal.

System 100 includes a laboratory analysis system 110 and an analysis data interpretation system 150. According to alternative embodiments, chemical analysis system 100 may include more, fewer, and/or different components configured to perform the functions described herein.

Although shown as a single system, chemical analysis system 100 may be configured to include multiple distinct systems. For example, system 100 may include a laboratory analysis system 110 connected to analysis data interpretation system 150 through a computer network.

Laboratory analysis system 110 may be an analysis system configured to deliver bioassay results in a laboratory analysis system output file 140. A bioassay is a determination of the strength or biological activity of a substance by comparing its effects with those of a standard preparation on a test organism. According to an exemplary embodiment, chemical analysis system 100 may be particularly configured to facilitate the identification and definition of the Histocompatiblity Antigens. Laboratory analysis system 100 may include a variety of components configured to generate the bioassay results, such as lasers, optics, fluidics, controllers, digital signal processors, bar code reader, etc. Laboratory analysis system 110 may further include software designed for template-based data acquisition with data regression analysis, further described below. According to an exemplary embodiment, laboratory analysis system 110 may be the Luminex® 100™ Total System, Luminex 100™ IS Total System, Luminex High Throughput Screening System, manufactured by Luminex Corporation of Austin, Tex. Alternatively, laboratory analysis system 110 may be any other type of laboratory system configured to deliver bioassay results.

In operation, laboratory analysis system 110 is configured to receive an HLA typing tray 115 containing one or more analytes. An analyte is any material or chemical substance subjected to analysis. For HLA analysis, the analyte may include the patient or donor's DNA for DNA typing and serum for antibody screening.

According to an exemplary embodiment, HLA typing tray 115 may be a Dynal HLA Typing Tray, which uses DNA as a substrate, manufactured by Dynal Biotech, LLC. of Brown Deer. Wis.

In operation, laboratory analysis system 110 may be configured to simultaneously assay up to 100 analytes in a single well of a microtiter plate, using very small sample volumes. In analyzing an analyte, system 110 may be configured to utilize a population of microspheres 120 including up to 100 distinct color-coded microspheres that differ by the ratio of two internal fluorescent dyes.

According to an exemplary embodiment, HLA typing tray 115 microspheres 120 are Luminex® color-coded tiny beads, called microspheres, which may have 100 shades of the same color. When added to a heterogeneous suspension, microspheres 120 will bind to the desired target (cells, nucleic acids, proteins or other biomolecules). This interaction is based on the specific affinity of the ligand on the surface of microspheres 120. The resulting target-bead complex can be removed from the suspension vie centrifugation. The supernatant is removed with a pipette.

Laboratory analysis system 110 contains a red laser that excites the dyes in the microspheres and categorizes them based on their dye content. The microspheres are coated with carboxyl groups that can be used to covalently attach specific HLA antigen preparations. The attached DNA or proteins may then be identified based on their association to a color-coded microsphere. In addition to the red laser, the instrument contains a green laser that is used to quantify the amount of fluorescently labeled material that is captured by the beads. Since each assay may contain thousands of each color-coded microsphere, the laboratory analysis system 110 may be designed so that the microspheres align single-file so that they pass one-by-one past the lasers to facilitate analysis.

The laboratory analysis system 10 reports the median fluorescent intensity of Polymerase Chain Reaction (PCR) product captured by each color-coded microsphere. Thus, for each sample, the instrument reports values for each microsphere. By comparing the values obtained for a given sample with known positive and negative values for each microsphere, a probe hit pattern is generated for the sample. The alleles present can then be determined by comparison of the probe hit pattern of a sample to a table of all possible probe hits in analysis data interpretation system 150, further described below. This can be done either manually or with the aide of computer software.

Laboratory analysis system 110 may further be configured to receive a test kit template file 130. Template file 130 is a pre-defined sequence of commands that a kit manufacturer creates to collect fluorescence information in the output from laboratory analysis system 10 and to store output data. The template system may be configured to be specific to the type of laboratory analysis system being used.

Microspheres 120 include a bead identification (ID). The bead ID may be a text string, including a number, letters, etc. to particularly identify a bead. Test kit template file 130 is configured to include the bead ID number information, which in turn, may be transferred to the laboratory analysis system output file 140. Currently, the only information that is transferred from the test kit template file 130 to the laboratory analysis system output file 140 is the bead ID. The bead ID may be modified to include test kit information, specifically an identification of the type of test kit that was used to generate the laboratory analysis system output file 140.

Analysis data interpretation system 150 may include software configured to facilitate interpretation of laboratory analysis system output file 140. According to an exemplary embodiment, analysis data interpretation system 150 may be the MatchPro application, manufactured by Dynal Biotech, LLC. of Brown Deer, Wis.

Analysis data interpretation system 150 normalizes the values obtained from laboratory analysis system and compares these values with preset thresholds for each microsphere 120. Positive and negative assignment to microsphere 120 can be determined based on the obtained values above or below thresholds. The positive assignment to the microsphere 120 becomes a match pattern that is used for search against a kit database. Allele pairs that have the combined pattern the same as the match pattern are therefore identified as typing results.

Advantageously, wherein the kit information is embedded in the bead ID stored in the laboratory analysis system output file 140, there is no need for a user to select from a listing of test kits to identify the type of kit that was used. This information may be automatically extracted by analysis data interpretation system 150 based on the information in the template 130. Removing human intervention in this process increases throughput and reduces the occurrence of errors.

Alternatively, the bead IDs themselves may serve as the identifier of the test kit type that is used. For example, a test kit manufacturer may utilize microspheres with bead IDs of 001, 002, 004, 005, etc. in a first kit type, and use bead IDs 001, 002, 003, 005, etc. for a second test kit type. The system and method include any method for identify the test kit type that is embedded within the test kit such that a human operator does not need to manually select a test kit type.

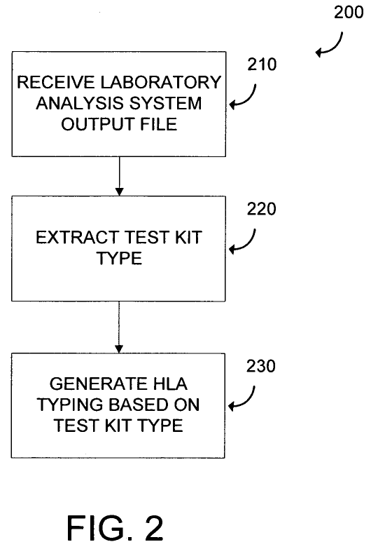

Referring now to FIG. 2, a flowchart illustrating a method 200 of automatically determining a test kit type used to generate laboratory analysis system output file 140 is shown, according to an exemplary embodiment. Although specific steps are shown in a specific order, it is understood that method 200 may include more, fewer, different, and/or a different ordering of the steps to perform the functions described herein.

In a step 210, analysis data interpretation system 150 is configured to receive laboratory analysis system output file 140 from laboratory analysis system 110. The file may be transferred from system 110 to system 150 through an internal process, a network, or any other method. The file includes a test kit identifier. The test kit identifier is included in the output file that is generated by chemical analysis system 100.

In a step 220, analysis data interpretation system 150 is configured to extract the test kit identifier from one or more bead ID stored in the laboratory analysis system output file 140. Analysis data interpretation system 150 may be configured to extract the test kit type from multiple bead IDs to reduce the possibility of misidentification. Alternatively, the test kit identifier may be determined based on the configuration of bead IDs that are present in the output file generated by chemical analysis system 100.

In a step 230, analysis data interpretation system 150 is configured to analyze the contents of the laboratory analysis system output file 140 based on the test kit identification information extracted in step 220 to generate HLA typing. Advantageously, wherein the test kit type is automatically identified, there is less chance for introduction of errors based on human intervention.

Embodiments within the scope of the present description include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions.

The invention is described in the general context of a process, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

Software and web implementations of the present invention could be accomplished with standard programming techniques with rule based logic and other logic to accomplish the various database searching steps, correlation steps, comparison steps and decision steps. It should also be noted that the word “system” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. An analysis data interpretation system configured to automatically identify a test kit type used to generate a laboratory system output file, the system comprising:
an analysis data interpretation processor configured to receive a laboratory system output file including a test kit identifier to identify the test kit that was used to generate the laboratory system output file.

2. The system of claim 1, wherein the laboratory system output file includes a median fluorescent intensity of PCR product captured by a plurality of color-coded microspheres.

3. The system of claim 2, wherein each microsphere includes an identification tag.

4. The system of claim 3, wherein the test kit identifier is embedded in the microsphere identification tag.

5. The system of claim 3, wherein the test kit identifier may be determined based on the microsphere identification tags that are present in the test kit.

6. The system of claim 1, wherein the analysis data interpretation processor is further configured to generate a genotyping based at least in part on the test kit identifier.

7. The system of claim 1, wherein the analysis data interpretation processor is further configured to generate a human leukocyte antigen typing based at least in part on the test kit identifier.

8. The system of claim 7, wherein the laboratory system output file includes a median fluorescent intensity of PCR product captured by a plurality of color-coded microspheres.

9. The system of claim 8, wherein the microsphere includes an identification tag.

10. The system of claim 9, wherein the test kit identifier is embedded in the microsphere identification tag.

11. A method for identifying a test kit type used to generate a laboratory system output file, the method comprising:
receiving a laboratory system output file;
identifying a test kit type used to generate a laboratory system output file based on the content of the laboratory system output file; and
generating at least one of an human leukocyte antigen typing, a genotyping, an antibody screening result, an expression analysis result, an inorganic identification result, and a cross match result based at least in part on the test kit identifier.

12. The method of claim 11, wherein the laboratory system output file includes a median fluorescent intensity of PCR product captured by a plurality of color-coded microspheres.

13. The method of claim 12, wherein the microsphere includes an identification tag.

14. The system of claim 13, wherein the test kit identifier is embedded in the microsphere identification tag.

15. The method of claim 14, wherein the test kit identifier is embedded in a test kit template file.

16. The system of claim 14, wherein the test kit identifier may be determined based on the microsphere identification tags that are present in the test kit.

17. An analysis data interpretation system configured to automatically identify a test kit type used to generate a laboratory system output file, the system comprising:
an analysis data interpretation means configured to receive a laboratory system output file including a test kit identifier to identify the test kit that was used to generate the laboratory system output file.

18. The system of claim 17, wherein the laboratory system output file includes a median fluorescent intensity of PCR product captured by a plurality of color-coded microspheres.

19. The system of claim 18, wherein each microsphere includes an identification tag.

20. The system of claim 19, wherein the test kit identifier is embedded in the microsphere identification tag.

21. The system of claim 19, wherein the test kit identifier may be determined based on the microsphere identification tags that are present in the test kit.

22. The system of claim 17, wherein the analysis data interpretation processor is further configured to generate at least one of a human leukocyte antigen typing, a genotyping, an antibody screening result, a cross match result, a expression analysis result, and an inorganic identification result based at least in part on the test kit identifier.

23. The system of claim 18, wherein the laboratory system output file includes a median fluorescent intensity of PCR product captured by a plurality of color-coded microspheres.

24. The system of claim 23, wherein the microsphere includes an identification tag.

25. The system of claim 24, wherein the test kit identifier is embedded in the microsphere identification tag.

26. The system of claim 24, wherein the test kit identifier may be determined based on the microsphere identification tags that are present in the test kit.

27. The system of claim 17, wherein the test kit identifier is embedded in a test kit template file.
